(19) United States
(12) Patent Application Publication
(10) Pub. No.: US 2006/0139518 A1
(43) Pub. Date: Jun. 29, 2006

(54) Liquid crystal display panel and method for manufacturing liquid crystal display panel units

(75) Inventors: Jia-Yi Wu, Miao-Li (TW); Kun-Hsing Hsiao, Miao-Li (TW); Tsau Hua Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,863

(22) Filed: Dec. 23, 2005

(30) Foreign Application Priority Data
Dec. 28, 2004 (TW) 93140994

(51) Int. Cl. G02F 1/1333

(52) U.S. Cl. 349/110

(57) ABSTRACT

An exemplary LCD panel (40) includes a first substrate (41) and a second substrate (42) opposite to each other, and a plurality of main sealants (43), a dummy sealant (44), and one or more dividing lines provided at one of the first and second substrates. The dummy sealant surrounds the main sealants. The dividing lines intersect the dummy sealant, the dummy sealant thereby define a plurality of overlap portions. And liquid crystal is disposed within each of the main sealants. A plurality of shielding portions (423) is provided at one of the first and second substrates, the shielding portions is positioned corresponding to the overlapped portions. With this configuration, it will be easier to cut the LCD panel into unit cells. Further, the LCD panel eliminates the need for mask, this decreases the costs thereof.

### FIELD OF THE INVENTION

The present invention relates to liquid crystal display (LCD) panels and their methods of manufacture, and especially to an LCD panel manufactured by a one-drop-fill (ODF) method.

### BACKGROUND

An LCD panel generally includes two glass substrates, a peripheral sealant, and a plurality of liquid crystal molecules disposed between the substrates. The sealant is printed on one of the glass substrates, and then adhered to the other glass substrate. The substrates and the sealant cooperatively form a space therebetween, with the liquid crystal molecules being filled in the space.

There are generally two methods used for filling the liquid crystal molecules into the space. The first method is to fill the liquid crystal molecules through filling ports. This method includes the following steps: firstly, coating a sealant on a first glass substrate, the sealant being rectangular and having one or more gaps that function as filling ports; secondly, attaching a second glass substrate to the first glass substrate and curing the sealant, with a space being enclosed by the sealant and the two glass substrates; thirdly, immersing the filling ports in a liquid crystal in a vacuum chamber; and finally, introducing gas into the vacuum chamber to make the liquid crystal molecules fill up the space.

The second method is the so-called one-drop-fill (ODF) method. This method comprises the following steps: firstly, printing a sealant on a first glass substrate, wherein the sealant is rectangular and continuous, and a space is enclosed by the sealant and the first glass substrate; secondly, putting liquid crystal molecules into the space drop by drop using a dispenser; and finally, combining a second glass substrate with the first glass substrate and curing the sealant.

Referring to FIG. 6, a conventional LCD panel 10 includes a first substrate 11 and a second substrate 12 disposed opposite to each other and spaced apart a predetermined distance, a plurality of main sealants 13 and a dummy sealant 14 coated on an inner surface of the first substrate 11, and a plurality of liquid crystal droplets 15 arranged on parts of the inner surface of the first substrate 11 surrounded by each of the main sealants 13. The number of main sealants 13 corresponds to the number of LCD panel units that the LCD panel 10 can eventually yield. Each panel unit is used in the manufacture of a corresponding LCD device. The liquid crystal droplets 15 in each main sealant 13 eventually form a liquid crystal layer of a corresponding LCD panel unit.

The main sealants 13 prevent the liquid crystal from leaking, and bond the first and second substrates 11, 12 together. The dummy sealant 14 is formed at a dummy region outside the main sealants 13, and is for protecting the main sealants 13.

Also referring to FIG. 7, this is a plan view showing a plurality of scribing lines 16, the main sealants 13, and the dummy sealant 14 formed on the first substrate 11 of the LCD panel 10. The scribing lines 16 are formed on the inner surface of the first substrate 11 using a scriber. The scribing lines 16 overlap portions of the dummy sealant 14, thereby defining overlapping regions. Accordingly, the portions of the dummy sealant 14 located at the overlapping regions are referred as overlapped portions 161.

Also referring to FIG. 8, in assembly, the first substrate 11 and the second substrate 12 are attached together. An ultraviolet irradiating device 17 is provided above the second substrate 12 for curing the sealants 13, 14, with a mask 18 being interposed between the ultraviolet irradiating device 17 and the second substrate 12. The mask 18 defines a plurality of shielding areas 181 corresponding to the overlapped portions 161 of the dummy sealant 14. The ultraviolet irradiating device 17 irradiates the second substrate 12 with ultraviolet (UV) rays and cures the sealants 13, 14. The substrates 11, 12 are thereby bonded together, and the LCD panel 10 is thus assembled. Then the LCD panel 10 is sheared along the scribing lines 16, thereby dividing the LCD panel 10 into a plurality of LCD panel units.

Because the overlapped portions 161 of the dummy sealant 14 are masked during the UV irradiation process, the overlapped portions 161 are not hardened. This makes shearing of the LCD panel 10 along the scribing lines 16 easier.

However, the need for the mask 18 increases the cost of the whole process. Further, the mask 18 must be accurately positioned between the ultraviolet irradiating device 17 and the second substrate 12, so that the shielding areas 181 are precisely located above the overlapped portions 161 of the dummy sealant 14. This can be time-consuming and troublesome. Further, if the mask 18 is not accurately positioned, the overlapped portions 161 may be cured or partly cured. When this happens, it is more difficult to shear the LCD panel 10 along the scribing lines 16.

Therefore, what is needed is an LCD panel which can overcome the above-described problems.

### SUMMARY

An LCD panel includes a first substrate and a second substrate opposite to each other, and a plurality of main sealants, a dummy sealant, and one or more dividing lines provided at one of the first and second substrates. The dummy sealant surrounds the main sealants. The dividing lines intersect the dummy sealant, the dummy sealant thereby define a plurality of overlap portions. And liquid crystal is disposed within each of the main sealants. A plurality of shielding portions is provided at one of the first and second substrates, the shielding portions is positioned corresponding to the overlapped portions.

A method for manufacturing the LCD panel includes the steps of: providing a first substrate and a second substrate; forming a plurality of main sealants, a dummy sealant, and one or more dividing lines at one of the first and second substrates, the dummy sealant surrounding the main sealants, the dividing lines intersecting the dummy sealant, the dummy sealant thereby defining a plurality of overlap portions; forming a plurality of shielding portions at one of the first and second substrates, the shielding portions being positioned corresponding to the overlapped portions of the dummy sealant; dropping a plurality of liquid crystal droplets on regions of said one of the first and second substrates which are surrounded by the main sealant; attaching the first and second substrates together; irradiating the main and dummy sealant with UV rays, with the overlapped portions shielded by the shielding portions, thereby bonding the first and second substrates together; and dividing the bonded substrates into a plurality of LCD units.

In summary, the shielding portions prevent UV rays from irradiating the overlapped portions of the dummy sealant. That is, the overlapped portions are not hardened so that it will be easier to cut the LCD panel into unit cells. Further, the LCD panel eliminates the need for mask, this decreases the costs thereof.

Other novel features and advantages will become more apparent from the following detailed description when taken in conjunction with the accompanying drawings.

### BRIEF DESCRIPTION OF THE DRAWINGS

FIG. 1 is a schematic, exploded, isometric view of an LCD panel according to a first embodiment of the present invention, the LCD panel comprising two substrates.

FIG. 2 is similar to FIG. 1, but showing the substrates attached together, and an ultraviolet irradiating device above the substrates irradiating a top one of the substrates with UV rays.

FIG. 3 is a schematic, exploded, isometric view of a plurality of LCD panel units obtained after dividing the duly irradiated LCD panel shown in FIG. 2.

FIG. 4 is a schematic, exploded, isometric view of an LCD panel according to a second embodiment of the present invention, the LCD panel comprising two substrates.

FIG. 5 is similar to FIG. 4, but showing the substrates attached together, and an ultraviolet irradiating device below the substrates irradiating a bottom one of the substrates with UV rays.

FIG. 6 is a schematic, exploded, isometric view of a conventional LCD panel, the LCD panel comprising two substrates.

FIG. 7 is a top plan view of a bottom one of substrates of the LCD panel of FIG. 6, showing main sealants, a dummy sealant, and a plurality of scribing lines formed thereon.

FIG. 8 is similar to FIG. 6, but showing the substrates attached together, and an ultraviolet irradiating device above the substrates irradiating a top one of the substrates with UV rays through a mask disposed therebetween.

### DETAILED DESCRIPTION OF PREFERRED EMBODIMENTS

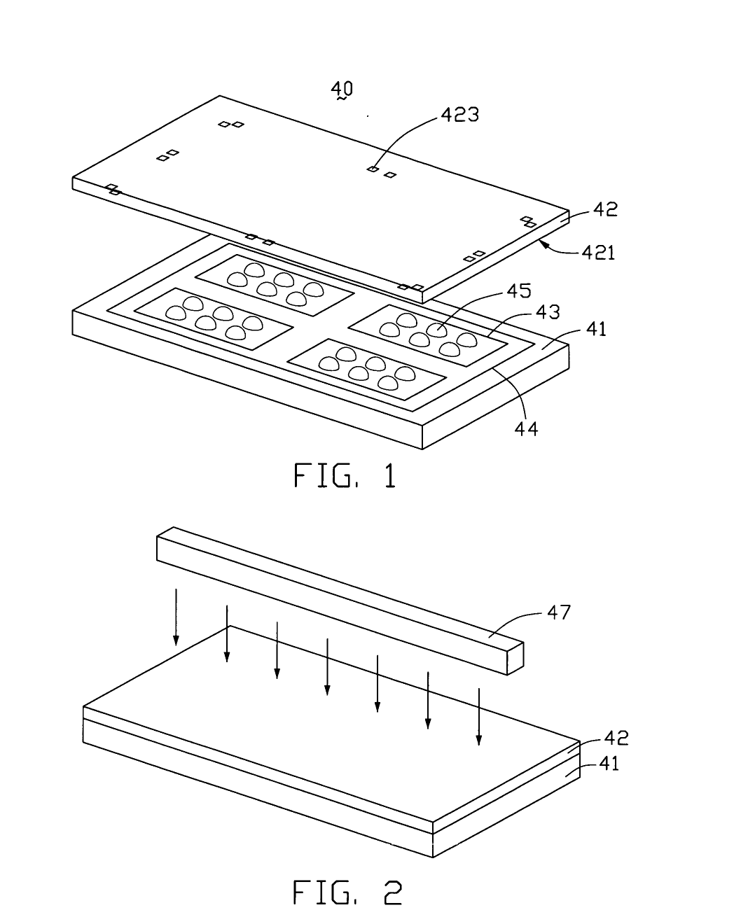

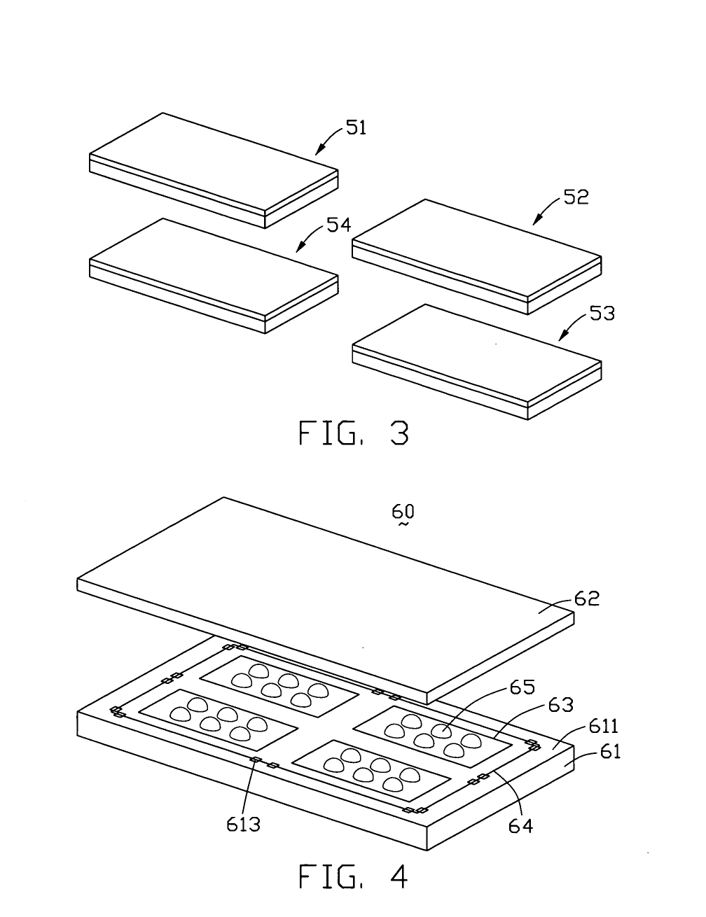

Referring to FIG. 1, an LCD panel 40 according to a first embodiment of the present invention includes a first substrate 41 and a second substrate 42 disposed opposite to each other and spaced apart a predetermined distance, a plurality of main sealants 43 and a dummy sealant 44 coated on an inner surface of the first substrate 41, and a plurality of liquid crystal droplets 45 on the inner surface of the first substrate 41 surrounded by each of the main sealants 43. The number of main sealants 43 corresponds to the number of LCD panel units (see FIG. 3) that the LCD panel 40 can eventually yield. Each panel unit is used in the manufacture of a corresponding LCD device. The liquid crystal droplets 45 in each main sealant 43 eventually form a liquid crystal layer of a corresponding LCD panel unit.

The main sealants 43 prevent the liquid crystal from leaking, and bond the first and second substrates 41, 42 together. The dummy sealant 44 is formed at a dummy region outside the main sealants 43, and is for protecting the main sealants 43.

A plurality of scribing lines (not shown) are formed on the inner surface of the first substrate 41 using a scriber. The scribing lines overlap portions of the dummy sealant 44, thereby defining overlapping regions. Accordingly, the portions of the dummy sealant 44 located at the overlapping regions are referred to as overlapped portions. A plurality of shielding portions 423 are formed at an inner surface 421 of the second substrate 42, and are positioned corresponding to the overlapped portions. The shielding portions 423 are portions of black matrix, which can prevent light beams from passing therethrough. The black matrix is a portion of color filter (not shown) formed at an inner surface 421 of the second substrate 42.

Also referring to FIG. 2, in assembly, the first substrate 41 and the second substrate 42 are attached together. An ultraviolet irradiating device 47 is provided above the second substrate 42. The ultraviolet irradiating device 47 irradiates the second substrate 42 with UV rays and cures the sealants 43, 44. The substrates 41, 42 are thereby bonded together, and the LCD panel 40 is thus assembled.

Also referring to FIG. 3, the LCD panel 40 is then sheared along the scribing lines, thereby dividing the LCD panel 40 into a plurality of LCD panel units 51, 52, 53, 54. Because the overlapped portions of the dummy sealant 44 are shielded by the shielding portions 423 during the UV irradiation process, the overlapped portions are not hardened. This makes shearing of the LCD panel 40 along the scribing lines easier.

In summary, the shielding portions 423 prevent UV rays from irradiating the overlapped portions of the dummy sealant 44. Thus the overlapped portions are not hardened, and it is easier to shear the LCD panel 40 into the individual LCD panel units 51, 52, 53, 54. Further, the LCD panel 40 eliminates the need for a mask in the assembly process, thereby reducing costs.

A method for manufacturing and dividing the LCD panel 40 includes the steps of: providing the first substrate 41 and the second substrate 42; forming the main sealants 43 and the dummy sealant 44 on the first substrate 41, the dummy sealant 44 surrounding the main sealants 43; forming the scribing lines on the first substrate 41, wherein portions of the dummy sealant 44 overlapped by the scribing lines are defined as the overlapped portions; forming the shielding portions 423 at the second substrate 42 at positions corresponding to the overlapped portions of the dummy sealant 44; dropping a plurality of liquid crystal droplets 45 on regions of the first substrate 41 surrounded by the main sealants 43; attaching the first and second substrates 41, 42 together; irradiating the sealants 43, 44 with UV rays, with the overlapped portions being shielded by the shielding portions 423, thereby bonding the substrates 41, 42 together and forming the LCD panel 40; and dividing the LCD panel 40 into the plurality of LCD panel units 51, 52, 53, 54.

In an alternative embodiment of the LCD panel 40, the shielding portions 423 can instead be formed at an outer surface of the second substrate 42. The shielding portions 423 are positioned corresponding to the overlapped portions of the dummy sealant 44. The shielding portions 423 maybe formed at the outer surface of the second substrate 42 by adhering.

Referring to FIG. 4, an LCD panel 60 according to a second embodiment of the present invention includes a first substrate 61 and a second substrate 62 disposed opposite to each other and spaced apart a predetermined distance, a plurality of main sealants 63 and a dummy sealant 64 coated on an inner surface 611 of the first substrate 61, and a plurality of liquid crystal droplets 65 on the inner surface of the first substrate 61 surrounded by each of the main sealants 63. The number of main sealants 63 corresponds to the number of LCD panel units that the LCD panel 60 can eventually yield. Each panel unit is used in the manufacture of a corresponding LCD device. The liquid crystal droplets 65 in each main sealant 63 eventually form a liquid crystal layer of a corresponding LCD panel unit.

The main sealants 63 prevent the liquid crystal from leaking, and bonds the first and second substrates 61, 62 together. The dummy sealant 64 is formed at a dummy region outside the main sealants 63, and is for protecting the main sealants 63.

A plurality of scribing lines (not shown) are formed on the inner surface of the first substrate 61 using a scriber. The scribing lines overlap portions of the dummy sealant 64, thereby defining overlapping regions. Accordingly, the portions of the dummy sealant 64 located at the overlapping regions are referred to as overlapped portions. A plurality of shielding portions 613 are formed at the inner surface 611 of the first substrate 61, and are positioned corresponding to the overlapped portions. The shielding portions 613 are made of opaque metal, which can prevent light beams from passing therethrough. The shielding portions 613 maybe formed at the inner surface 611 of the first substrate 61 at the same time with gate and/or source electrode.

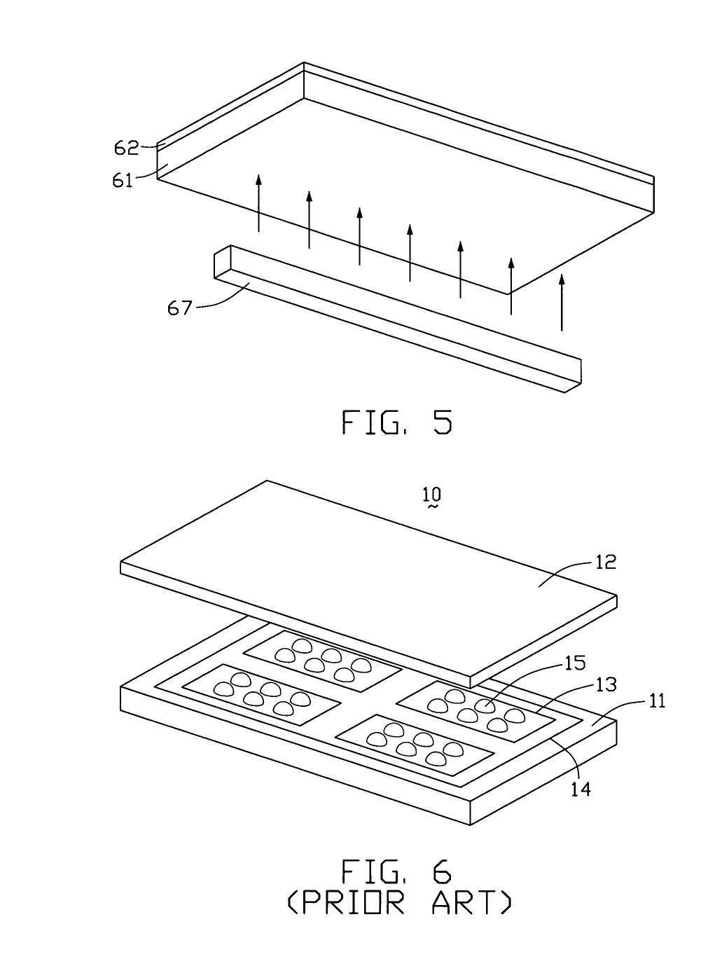

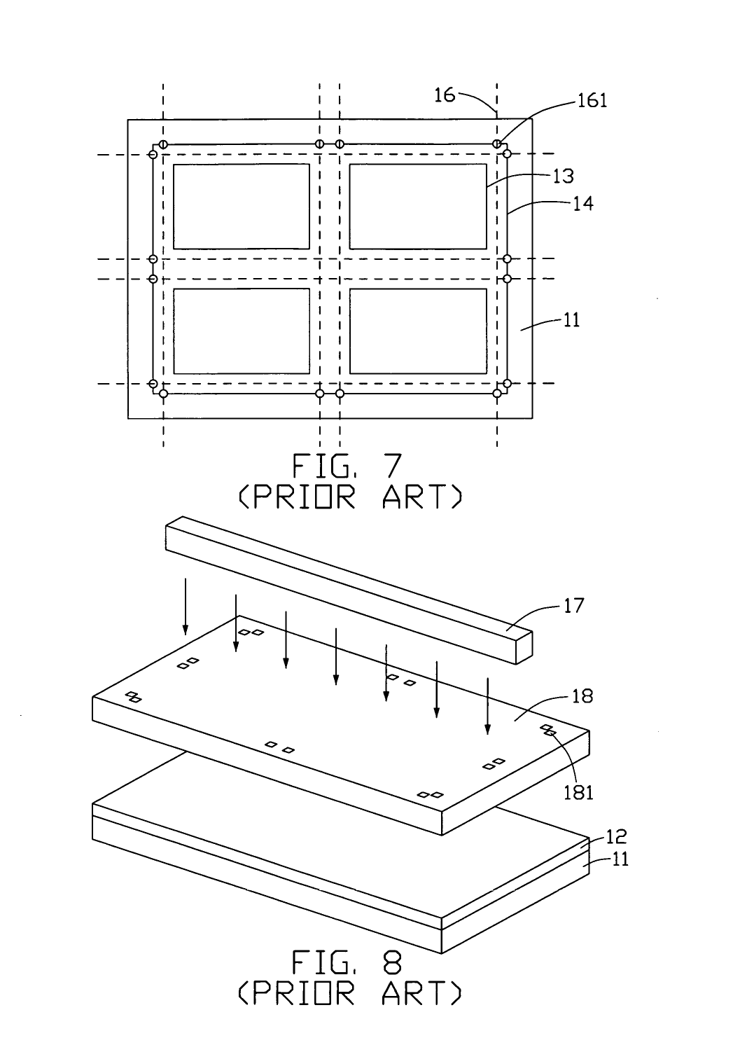

Also referring to FIG. 5, in assembly, the first substrate 61 and the second substrate 62 are attached together. An ultraviolet irradiating device 67 is provided below the first substrate 61. The ultraviolet irradiating device 67 irradiates the first substrate 61 with UV rays and cures the sealants 63, 64. The substrates 61, 62 are thereby bonded together, and the LCD panel 60 is thus assembled.

The LCD panel 60 is then sheared along the scribing lines, thereby dividing the LCD panel 60 into a plurality of LCD panel units. Because the overlapped portions of the dummy sealant 64 are shielded by the shielding portions 613 during the UV irradiation process, the overlapped portions are not hardened. This makes shearing of the LCD panel 60 along the scribing lines easier.

In summary, the shielding portions 613 prevent UV rays from irradiating the overlapped portions of the dummy sealant 64. Thus, the overlapped portions are not hardened, and it is easier to shear the LCD panel 60 into the individual LCD panel units. Further, the LCD panel 60 eliminates the need for a mask in the assembly process, thereby reducing costs.

A method for manufacturing and dividing the LCD panel 60 includes the steps of: providing the first substrate 61 and the second substrate 62; forming the main sealants 63 and the dummy sealant 64 on the first substrate 61, the dummy sealant 64 surrounding the main sealants 63; forming the scribing lines on the first substrate 61, wherein portions of the dummy sealant 64 overlapped by the scribing lines are defined as the overlapped portions; forming the shielding portions 613 at the first substrate 61 at positions corresponding to the overlapped portions of the dummy sealant 64; dropping a plurality of liquid crystal droplets 65 on regions of the inner surface 611 of the first substrate 61 surrounded by the main sealants 63; attaching the first and second substrates 61, 62 together; irradiating the sealants 63, 64 with UV rays, with the overlapped portions being shielded by the shielding portions 613, thereby bonding the substrates 61, 62 together and forming the LCD panel 40; and dividing the LCD panel 60 into a plurality of LCD panel units.

In an alternative embodiment of the LCD panel 60, the shielding portions 613 can instead be formed at an outer surface of the first substrate 61. The shielding portions 613 are positioned corresponding to the overlapped portions of the dummy sealant 64. The shielding portions 613 maybe formed at the outer surface of the first substrate 61 by adhering.

Also in an alternative embodiment of the LCD panels, the dummy sealant can instead overlap the scribing lines.

It is to be understood, however, that even though numerous characteristics and advantages of various embodiments have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A liquid crystal display panel, comprising:
a first substrate and a second substrate opposite to each other;
a plurality of main sealants, a dummy sealant, and one or more dividing lines provided at one of the first and second substrates, the dummy sealant surrounding the main sealants, the dividing lines intersecting the dummy sealant, the dummy sealant thereby defining a plurality of overlap portions; and
liquid crystal within each of the main sealants; and
a plurality of shielding portions provided at one of the first and second substrates, the shielding portions being positioned corresponding to the overlap portions.

2. The liquid crystal display panel as claimed in claim 1, wherein the shielding portions are provided at an outer surface of the second substrate.

3. The liquid crystal display panel as claimed in claim 1, wherein the shielding portions are provided at an inner surface of the second substrate.

4. The liquid crystal display panel as claimed in claim 1, wherein the shielding portions are provided at an outer surface of the first substrate.

5. The liquid crystal display panel as claimed in claim 1, wherein the shielding portions are provided at an inner surface of the first substrate.

6. The liquid crystal display panel as claimed in claim 1, wherein the shielding portions are made of opaque metal.

7. The liquid crystal display panel as claimed in claim 1, wherein the overlap portions are portions of the dummy sealant overlapped by the dividing lines.

8. The liquid crystal display panel as claimed in claim 7, wherein the dividing lines are scribing lines, which are used for cutting the liquid crystal display panel into a plurality of liquid crystal display panel units.

9. A method for fabricating a plurality of liquid crystal display panel units, comprising:
providing a first substrate and a second substrate;
forming a plurality of main sealants, a dummy sealant, and one or more dividing lines at one of the first and second substrates, the dummy sealant surrounding the main sealants, the dividing lines intersecting the dummy sealant, the dummy sealant thereby defining a plurality of overlap portions;
forming a plurality of shielding portions at one of the first and second substrates, the shielding portions being positioned corresponding to the overlap portions of the dummy sealant;
dropping a plurality of liquid crystal droplets on regions of said one of the first and second substrates which are surrounded by the main sealants;
attaching the first and second substrates together;
irradiating the main and dummy sealants with UV rays, with the overlap portions shielded by the shielding portions, thereby bonding the first and second substrates together; and
dividing the bonded substrates into a plurality of liquid crystal display panel units.

10. The method as claimed in claim 9, wherein the overlap portions of the dummy sealant are overlapped by the dividing lines.

11. The method as claimed in claim 9, wherein the shielding portions are formed at an outer surface of the second substrate.

12. The method as claimed in claim 9, wherein the shielding portions are formed at an inner surface of the second substrate.

13. The method as claimed in claim 9, wherein the shielding portions are formed at an outer surface of the first substrate.

14. The method as claimed in claim 9, wherein the shielding portions are formed at an inner surface of the first substrate.

15. The method as claimed in claim 9, wherein the shielding portions are made of opaque metal.
